(19) United States
(12) Patent Application Publication
(10) Pub. No.: US 2014/0358754 A1
(43) Pub. Date: Dec. 4, 2014

(54) Mobile Giving

(71) Applicants: Aaron Breeden, Spokane, WA (US); Christopher Marcus, New York, NY (US); Todd Hughes, New York, NY (US)

(72) Inventors: Aaron Breeden, Spokane, WA (US); Christopher Marcus, New York, NY (US); Todd Hughes, New York, NY (US)

(21) Appl. No.: 13/909,218

(22) Filed: Jun. 4, 2013

(51) Int. Cl. G06Q 30/00

(52) U.S. Cl. CPC G06Q 30/018
USPC 705/35

(57) ABSTRACT

A donation may be made through a mobile platform. In some instances, a particular series of pages may be provided through a mobile device to enable a user to donate in a relatively small number of steps. The series of pages may allow a user who has previously registered with the platform to relatively quickly identify a non-profit organization to which to make a donation, submit an amount of funds for the donation, and view feedback information related to donation activities associated with the user. Donation activity data from a plurality of devices may also be analyzed to generate donation information. In some instances, the donation information may provide information regarding types of donations that are being made, times and location of donations, types of users that are making donations, and so on.

### BACKGROUND

Many individuals donate to non-profit organizations. In some instances, an individual may donate by visiting an online site associated with a non-profit organization to complete a detailed form. In another instance, the individual may deliver cash, a check, or another financial instrument to a representative of the non-profit organization. However, these processes for donating are often time consuming and require the individual to carry a check book or cash. Accordingly, there is an increasing need to enable individuals to donate to non-profit organizations in an efficient manner.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates an example architecture in which techniques described herein may be implemented.

FIGS. 2A-2C illustrate example interfaces that may be presented to enable a user to donate in a relatively small number of steps.

FIG. 3 illustrates an example interface that displays statistics regarding donation activities of a user.

FIG. 4 illustrates an example interface that displays progress of a user toward donation goals.

FIGS. 5A-5B illustrate example interfaces that display chain-of-impact information items indicating an impact of donation activities associated with a user.

FIG. 6 illustrates an example interface to enable a user to create and share information regarding donation activities of the user.

FIG. 7 illustrates an example interface that displays information regarding a non-profit organization.

FIG. 8 illustrates an example interface that displays a donation report for a particular non-profit organization.

FIG. 9 illustrates an example process to facilitate a donation through a device.

FIG. 10 illustrates an example process to analyze donation activity data to generate donation information.

### DETAILED DESCRIPTION

As discussed above, current techniques for charitable giving are often time consuming and require an individual to carry particular items. For example, an individual that is required to donate to separate non-profit organizations through separate online sites may spend considerable time establishing accounts for each non-profit organization and completing forms for donations. In another example, an individual may be required to carry a check or cash to make a donation. Accordingly, there is an increasing need to enable individuals to donate in an efficient manner.

This disclosure describes, in part, techniques for making donations through a mobile platform. In one example, the mobile platform may provide a series of pages through a mobile device, such as a smart phone, to enable a user to donate in a relatively small number of steps. The series of pages may allow a user who has previously registered with the platform to relatively quickly identify a non-profit organization to which to make a donation, submit an amount of funds for the donation, and view feedback information related to donation activities associated with the user (e.g., donations from the user or friends of the user, invitations by the user to encourage others to donate, pledges to donate from the user, etc.). The feedback information may include a chain-of-impact item that shows an impact of the donation activities, trends or metrics of the user regarding the donation activities, rewards for the donation activities, progress toward a donation goal, and so on.

In some instances, by making a donation through a mobile platform, a user may utilize an item that may generally be available to the user, namely a mobile device. This may allow the user to avoid carrying a check book, cash, or other financial instrument to make a donation. Further, by enabling the user to make donations to multiple non-profit organizations through a single platform, the user may make donations in a simplified manner, in comparison to previous techniques that require the user to utilize separate sites for donations to separate non-profit organizations. Additionally, by enabling the user to make a donation with a relatively small number of steps (e.g., through a set of three to five pages), the donation may be made relatively quickly, in comparison to previous techniques. Moreover, by providing feedback information to a user upon completing a donation, or at other times, the user's experience may be enhanced.

This disclosure also describes techniques for processing a collection of donation activity data from multiple devices to generate donation information. In one example, donation activity data is collected from a plurality of mobile devices. The donation activity data may provide general information about a donation, such as an amount of funds donated, a time of the donation, a location of a mobile device at the time of the donation, a non-profit organization to which the donation was made, and so on. The donation activity data may be analyzed to generate donation information related to donation activities of the mobile devices. For example, the donation information may indicate a best time of day at which donations are made (e.g., more than 75% of people are giving right after dinner), a trend in donations of users (e.g., an increasing number of people are giving this month, etc.), a location at which a threshold number of users are making donations (e.g., a large number of users are giving while at the local coffee shop), and so on. The donation information may be provided in a report to a non-profit organization or user to provide insights regarding the donation activities of the mobile devices.

In some instances, by analyzing donation activity data from mobile devices, the techniques discussed herein may provide rich information regarding donation activities of users. For example, the techniques may enable non-profit organizations and others to gain knowledge about the types of donations that are being made, times and locations of donations, the types of users that are making donations, and so on. This may assist a non-profit organization in scheduling a fund raising campaign or another event.

Although many of the techniques are discussed herein in context of mobile devices and platforms (e.g., donating through a mobile device, collecting information from mobile devices, etc.), these techniques may be implemented in the context of other devices and platforms, such as a desktop or laptop computer, a cloud-based environment, and so on.

This brief introduction is provided for the reader's convenience and is not intended to limit the scope of the claims. Furthermore, the techniques described in detail below may be implemented in a number of ways and in a number of contexts. One example implementation and context is provided with reference to the following figures, as described below in more detail. However, the following implementation and context is but one of many.

### Example Architecture

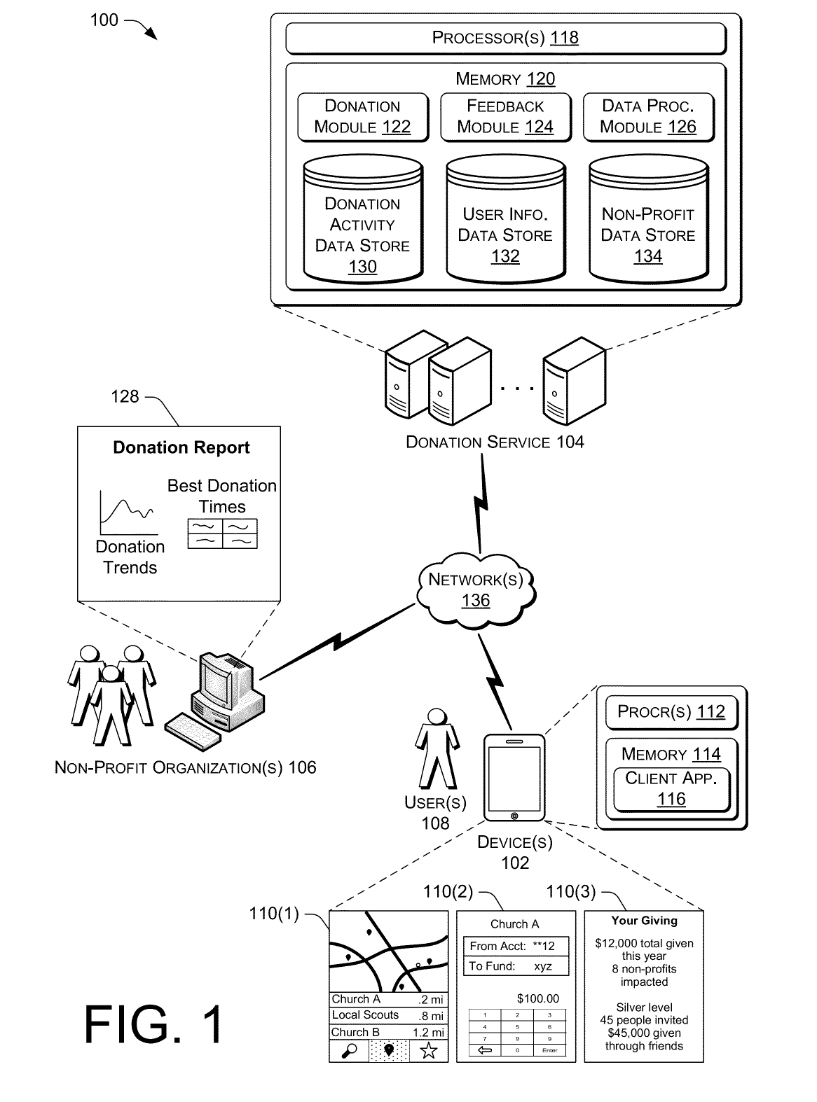

FIG. 1 illustrates an example architecture 100 in which techniques described herein may be implemented. The architecture 100 includes one or more devices 102 (hereinafter “the device 102”) configured to communicate with a donation service 104 and/or one or more non-profit organizations 106 (hereinafter “the non-profit organization 106”) to facilitate a donation. For example, the device 102 may enable a user 108 to donate to the non-profit organization 106 through a series of pages 110(1)-110(3) that are presented on the device 102. Through the page 110(1) the user 108 may select a non-profit organization, through the page 110(2) the user 108 may input an amount of funds to be donated to the non-profit organization, and through the page 110(3) the user 108 may view feedback information related to the user's giving. In this example, the feedback information indicates an amount of funds the user 108 has donated during the past year, rewards the user 108 has earned for giving (e.g., silver level), a number of people that the user 108 has invited to donate, and an amount of funds that friends of the user have donated.

The device 102 may comprise a laptop computer, a desktop computer, a smart phone, an electronic reader device, a mobile handset, a personal digital assistant (PDA), a portable navigation device, a portable gaming device, a tablet computer, a watch, a portable media player, and the like. In some instances herein, the device 102 may be referred to as a mobile device, indicating that the device 108 is portable. In some instances, a mobile device includes any of the examples listed above except for the desktop computer.

The device 102 may be equipped with one or more processors 112 and memory 114. The memory 114 may include a client application 116 (e.g., module) configured to interface with the user 106 and perform other functionality. For instance, the client application 116 may output the pages 110(1)-110(3) to receive input from the user 108 for a donation. In many examples, the device 102 implementing the client application 116 comprises a mobile platform for making donations. The client application 116 may operate in cooperation with the donation service 104. For example, the page 110(1) may provide non-profit organizations that are determined by the donation service 104 to be within a predetermined distance to the device 102, while the page 110(3) may provide information that is received from the donation service 104.

The donation service 104 may include one or more computing devices, such as one or more desktop computers, laptop computers, servers, and the like. The one or more computing devices may be configured in a cluster, data center, cloud computing environment, or a combination thereof. In one example, the one or more computing devices provide cloud computing resources, including computational resources, storage resources, and the like, that operate remotely to the device 102 and/or the non-profit organization 106. In some instances, the donation service 104 is associated with the non-profit organization 106 (e.g., managed by or otherwise administered by the non-profit organization 106).

The one or more computing devices of the donation service 104 may include one or more processors 118 and memory 120. The memory 120 may include software functionality configured as one or more “modules.” The term “module” is intended to represent example divisions of the software for purposes of discussion, and is not intended to represent any type of requirement or required method, manner or organization. Accordingly, while various “modules” are discussed, their functionality and/or similar functionality could be arranged differently (e.g., combined into a fewer number of modules, broken into a larger number of modules, etc.). Further, while certain functions and modules are described herein as being implemented by software and/or firmware executable on a processor, in other embodiments, any or all of the modules may be implemented in whole or in part by hardware (e.g., as an ASIC, a specialized processing unit, etc.) to execute the described functions. As illustrated in FIG. 1, the memory 120 includes a donation module 122, a feedback module 124, and a data processing module 126.

The donation module 122 may generally manage donations to non-profit organizations. The donation module 122 may provide functionality to enable the user 108 to identify a non-profit organization to donate to, such as search functionality for the user 108 to search through a plurality of non-profit organizations, proximity functionality for the user 108 to view non-profit organizations that are located relatively close the device 102, and so on. In some instances, the donation module 122 may manage favorite non-profit organizations that the user 108 has identified. Additionally, or alternatively, the donation module 122 may cause donations to non-profit organizations to be carried out by instructing financial institutions to make transfers between financial accounts, instructing a third party service (e.g., PayPal®) to handle the transfers, and so on. The donation module 122 may also maintain donation activity history of users, such as what donations are made, times and amounts of the donations, locations where the users where located when making the donations, non-profit organizations to which the donations were made, and so on.

As used herein, a donation activity may include any type of activity related to donating. Examples of such activities include making a donation to a non-profit organization, making a pledge for a donation, sharing information with other users regarding a donation activity of a user, inviting other users to make a donation or pledge, and so on.

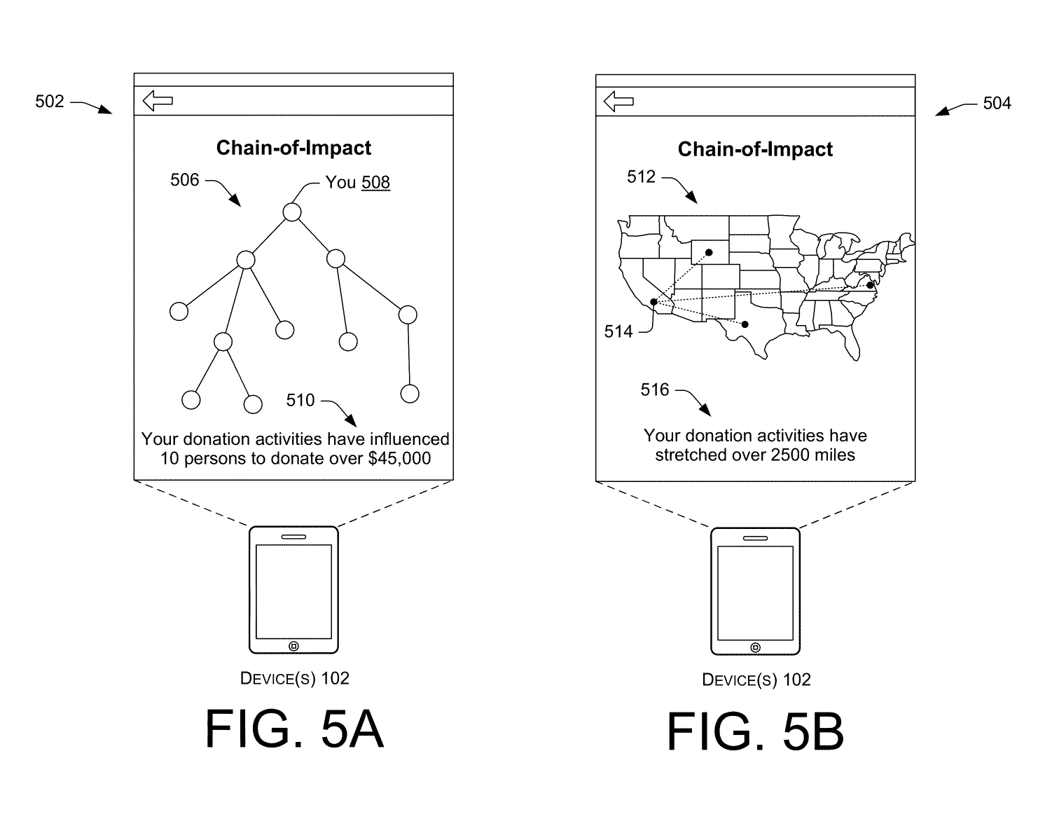

The feedback module 124 may generate and/or provide feedback information. For example, after making a donation through the device 102, the feedback module 124 may provide information that indicates how the user 108 is progressing toward a donation goal for that year. A few examples of feedback information include:
A chain-of-impact information item that indicates an impact of donation activities of a user. Example chain-of-impact information items are discussed below in reference to FIGS. 5A-5B.
A comparison information item that compares donation activities of a user with donation activities of other users (e.g., you rank in the top 95% of giving for user's of your income level). In some examples, the comparison information item may compare donation activities of users that have characteristics that are deemed to be similar (e.g., above a threshold of similarity), such as users of a similar age, income level, geographical area, interests (e.g., sports, movies, etc.), profession, education level, or any other type of information.
Metrics (e.g., statistics) regarding a user's donation activities (e.g., you donate more money when you are at home than when you are at work).
A trend in donation activities of one or more users over a period of time.
Rewards for donation activities. Example rewards include points that a user has earned due to one or more donation activities, a graphically displayed badge that the user has earned due to one or more donation activities, a level of donation achievement that the user has earned due to one or more donation activities, unlocking levels of a game, and so on.
An inspirational quote or story regarding donating (e.g., “people that give more than $2,000 tend to live longer,” a story of how someone's health was saved due to funds received from an organization, and so on).
An animation (e.g., a graphic of a tree that grows each time a donation is made to either a specific non-profit organization or to any organization, a graphic of an dog that is fed when a donation is made, etc.).
A suggestion to assist/encourage a user to donate (e.g., “if you donate the money you spend on a cup of coffee each week for a month, you can feed a starving child in Africa for three months”).

The data processing module 126 may process donation activity data, as well as other information, to generate donation information. For example, the data processing module 126 may collect donation activity data related to donation activities carried out on a plurality of devices (e.g., mobile devices) and analyze the collected data to generate donation information. The donation information may comprise a metric (e.g., statistic) or any other type of information that relates to donation activities. In some instances, the donation information is specific to a particular user, such as an average amount of funds that a user donates, while in other instances the donation information may represent information for a plurality of users, such as an average amount of funds that users donate to a particular non-profit organization. The donation information may be provided in a report 128 to the non-profit organization 106, the device 102, and/or others. A few examples of donation information include:
A best time of day at which donations are made (e.g., a time of day at which donations satisfy one or more criteria). This information may be based on how frequently donations are made throughout the day (e.g., more donations are received at 5 PM than any other time of the day) and/or an amount of the donations (e.g., the largest donations are made around 9 AM). In some instances, this information may be specific to a particular location (e.g., at the local soup kitchen, donations are most frequently made at 5:30 PM).
A trend in donation activities (e.g., an increasing number of users have been donating to a particular church, a decreasing number of users over the age of 40 have been donating over the last year, etc.).
An average amount of donations to a particular non-profit organization, at a particular location, through a particular type of device (e.g., tablet vs. cell phone), by a particular type of user, and so on.
A location at which a threshold number of donations are being made and/or at which donations of a threshold amount are being made.
A type of user that makes a donation above a threshold and/or makes more than a threshold number of donations (e.g., people that exercise donate the most, doctors are donating more than any other profession, etc.).
How long after arriving at a particular location a user makes a donation.
Demographics information on reoccurring donations or pledges to donate (e.g., a particular type of person that frequently gives).
A pledge-to-donation conversion rate (e.g., a percentage of pledges that convert to actual donations).
A type of feedback information that motivates users to donate. For example, the donation information may indicate that people who view inspirational quotes after donating are more likely to donate again, in comparison to users that view their own donation statistics.
A type of campaign or notification (e.g., alert) that motivates users to donate again (e.g., users frequently donate to the “clothe the local children campaign”).

As illustrated in FIG. 1, the donation service 104 may include data stores 130-134. The donation activity data store 130 may store donation data related to donation activities of the device 102. The donation data may be collected overtime from a plurality of devices as users of those devices make donations through the plurality of devices.

The user information data store 132 may store user information of users that have registered with the donation service 104 and/or otherwise donate through the donation service 104 or another service. The user information may indicate any type of characteristic of a user, such as gender, income, education, residence, preferences, demographics, occupation, employer, family relationships, friends of a social networking site or blog, age, height, weight, and so on. This user information is obtained and/or maintained with the explicit knowledge and consent of users and/or in an anonymized manner that removes identifying information of the users (e.g., name). The user information may be used to identify users of a same type (e.g., that have similar characteristics) and/or to make comparisons between users' donation activities.

In some instances, the user information includes account information. The account information may include information about a financial account of the user from which to pull funds when a donation is made. This may allow a donation to be made automatically when a donation is initiated at the device 102. The account information may also include other types of information that the user has registered with the donation service 104, such as login information, donation goals, favorite non-profit organizations, reminders, and so on.

The non-profit data store 134 may store information related to the non-profit organization 106. This information may include campaign information related to donation campaigns to raise money, financial information about the non-profit organization 106 (e.g., how much donations are raised each year, how donations are used, etc.), general information about the non-profit organization 106 (e.g., organization mission statement, organization establishment date, location, employees, etc.), rating/rankings of the non-profit organization 106 (e.g., determined by third parties or the donation service 104), and so on.

The non-profit data store 134 may include information to be pushed to users as notifications. For example, the non-profit data store 134 may include campaign information to be pushed to users to solicit donations from the users (e.g., “Would you like to contribute to the save our trees campaign of Local Church A”). In some instances, a notification is pushed to a user when it is determined that a device of the user is within a predetermined distance to a site of a non-profit organization. Alternatively, or additionally, the notification may be pushed when the information is received from the non-profit organization and the user has indicated interest in the non-profit organization (e.g., viewed information of the non-profit organization, saved to favorites, etc.). In an illustration, a user that is parking in a lot for church may receive a notification from the church to contribute to a particular cause. In another illustration, a missionary that is knocking doors may push a notification regarding a campaign to a person that he comes in contact with.

Although in the example architecture 100 of FIG. 1, the modules 122-126 and the data stores 130-134 are illustrated as being included in the donation service 104, one or more of these elements may be included in the device 102 and/or the non-profit organization 106. As such, in some instances the donation service 104 may be eliminated entirely and/or replaced by the device 102 and/or the non-profit organizations 106.

The memory 114 and/or 120 (as well as all other memory described herein) may include one or a combination of computer storage media (e.g., computer-readable storage media). Computer storage media includes volatile and non-volatile, removable and non-removable media implemented in any method or technology for storage of information, such as computer readable instructions, data structures, program modules, or other data. Computer storage media includes, but is not limited to, phase change memory (PRAM), static random-access memory (SRAM), dynamic random-access memory (DRAM), other types of random access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device. As defined herein, computer storage media does not include communication media, such as modulated data signals and carrier waves. As such, computer storage media is limited to non-transitory media.

The non-profit organization 106 may include, for example, any type of organization that operates without distributing surplus revenues as profits or dividends. In some instances, a non-profit organization may be defined by an association, a governmental entity (e.g., the Internal Revenue Service (IRS)), and so on. Some examples of non-profit organizations include churches, boy/girl scouts, community centers, adoption agencies, parks or recreational facilities, charity organizations, and so on.

The architecture 100 may also include one or more networks 136 to enable the device 102, the donation service 104, and/or the non-profit organizations 106 to communicate with each other. The one or more networks 136 may include any one or combination of multiple different types of networks, such as cellular networks, wireless networks, Local Area Networks (LANs), Wide Area Networks (WANs), and the Internet.

### Example Interfaces

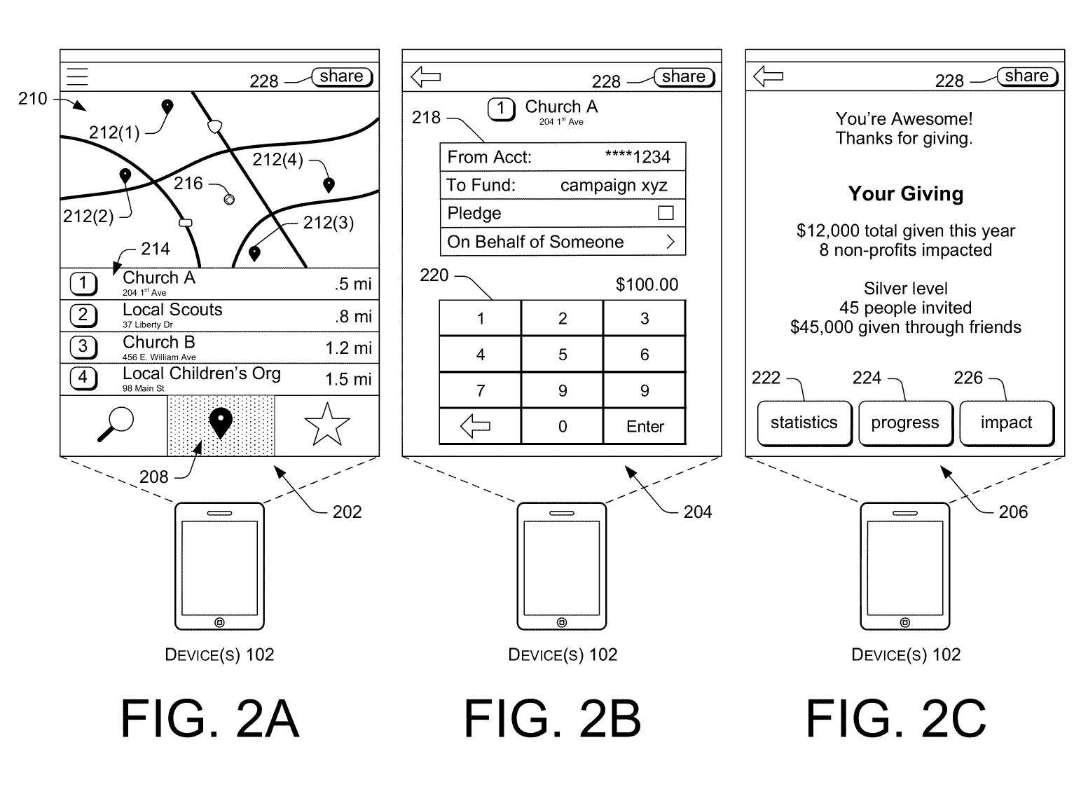

FIGS. 2-8 illustrate example interfaces that may be presented to a user to facilitate the donation techniques and/or data processing techniques discussed herein. The interfaces may be displayed through a browser, an application (e.g., the client application 116), and so forth.

FIGS. 2A-2C illustrate example interfaces 202-206 that may be presented to enable a user to donate in a relatively small number of steps (e.g., three to five steps). FIG. 2A illustrates the example interface 202 to identify a non-profit organization. In this example, the user has selected a proximity icon 208 to view non-profit organizations that have sites that are located within a predetermined distance to the user's device. A site of a non-profit organization may include a stationary site, such as an actual building of a non-profit organization, and/or may include a mobile site, such as a representative of a non-profit organization. A mobile site of a non-profit organization may be based on a location of a device of a representative (e.g., a missionary, boy scout, etc.).

As illustrated in FIG. 2A, the interface 202 includes a map 210 with markings 212(1)-212(4) for non-profit organizations that are in close proximity to the user and includes a listing 214 of those non-profit organizations along with proximity information (e.g., how many miles away a non-profit organization's site is located). An icon 216 may indicate a current location of the user. The user may identify a non-profit organization to donate to by selecting one of the markings 212(1)-212(4) and/or one of the non-profits organizations in the listing 214.

Although in the example of FIG. 2A the user identifies a non-profit organization through a map view, in other examples a user may search through non-profit organizations (e.g., through selection of the magnifying glass icon) and/or view a listing of non-profit organizations that have been saved as favorites (e.g., through a selection of the star icon). In one example of the search functionality, a user may search through non-profit organizations that are favorites of other users (e.g., friends of a social network). This may enable the user to make a donation on behalf of another user to a non-profit organization associated with that user.

FIG. 2B illustrates the example interface 204 to identify a donation to be made to a selected non-profit organization. The interface 204 may be displayed in response to selecting a non-profit organization through the interface 202. In the example of FIG. 2B, the user has selected to make a donation to Church A. The interface 204 includes an area 218 to specify an account to use for making a donation (e.g., by inputting an account number, selecting from a previously registered account, etc.), a fund to which a donation is to be made (e.g., a particular campaign that Church A is currently running), whether or not the donation is an actual donation or a pledge to donate (e.g., promise to donate in the future), and whether or not the donation is going to be made on behalf of someone else. If a user desires to make a donation on behalf of someone else, the user may input the person's name upon selecting the text “On Behalf of Someone.” Here, the user may also select from a list of non-profit organizations that are favorites of the other user. Further, if a user desires to make a pledge to donate (e.g., through selection the illustrated check box), the user may not be required to enter account information at this point, but may be asked to do so at a later time. In some instances, the area 218 may include an input field for specifying a group or group campaign for which the donation is being made (e.g., “group giving”—a group of users that are collectively giving to a cause). The interface 204 also includes a number pad 220 to input an amount of funds to be donated (e.g., $100 in this example).

FIG. 2C illustrates the example interface 206 that provides feedback information related to donation activities of the user. As noted above, a donation activity may relate to a current or previous donation or pledge, an invitation to others to donate, and so on. In this example, the interface 206 displays a total amount of funds that have been donated by the user this year (e.g., $12,000), a number of non-profit organizations that have been impacted (e.g., a number of non-profit organizations that the user has donated to), information indicating that the user has reached a silver level for donating, a number of people that the user has invited to donate (e.g., through a social networking site), and an amount of funds that have been donated through friends of the user (e.g., friends of a social networking site). Although specific types of feedback information are illustrated in the example interface 206, any type of feedback information may be presented.

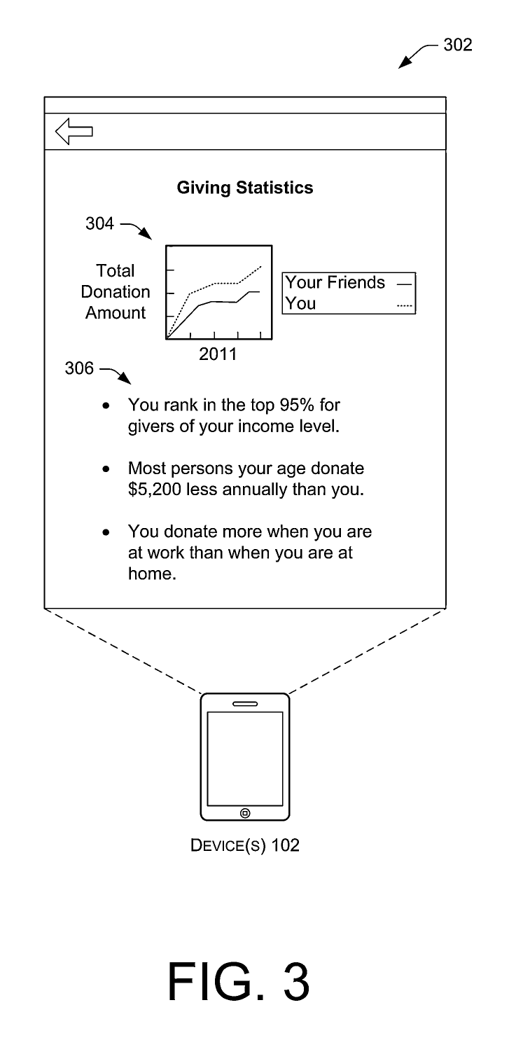

The interface 206 of FIG. 2C also includes a statistics icon 222 to view statistics related to donation activities associated with the user, a progress icon 224 to view information related to donation goals of the user, and an impact icon 226 to view the user's impact of donation activities. Example interfaces that may be presented in response to selection of one of the icons 222-226 are discussed below in reference to FIGS. 3-5.

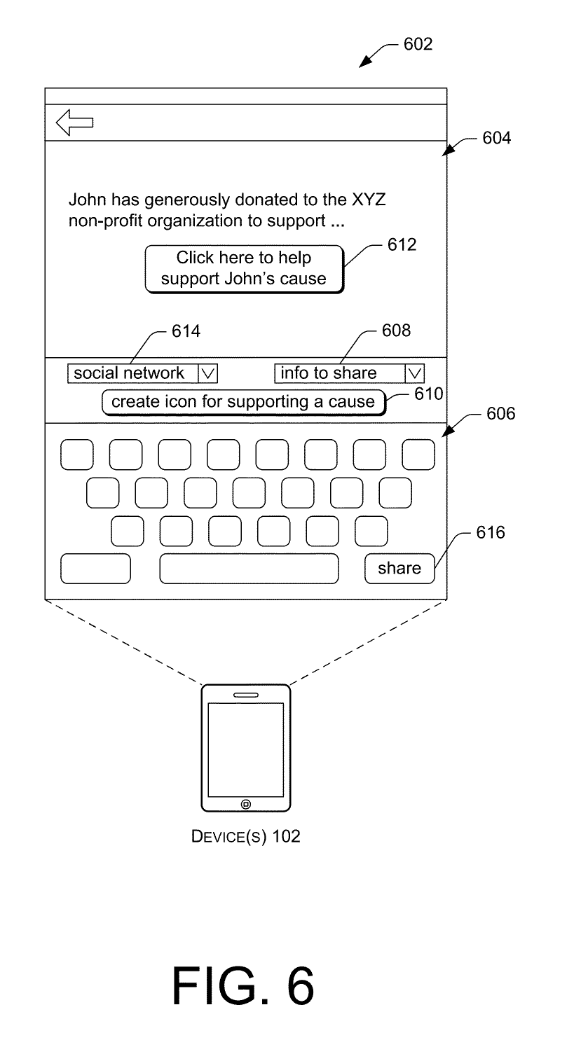

As illustrated in FIGS. 2A-2C, at any point while making a donation, the user may select a share icon 228 to share information about the user's giving, such as through a social networking site. An example interface to share information is discussed below in reference to FIG. 6.

FIG. 3 illustrates an example interface 302 that displays statistics regarding donation activities of a user. The interface 302 may be presented in response to selection of the statistics icon 222 in FIG. 2C. The interface 302 includes a graph 304 that shows a comparison of the user's donations over a particular period of time (e.g., a year) relative to another user's donations. In this example, the user's donations are compared to that of friends of a social networking site. In other examples, the user's donations may be compared to other users, such as users that are deemed to have similar characteristics. Although in this example the graph 304 shows a total amount of funds that are donated over time, other information may be similarly graphed, such as times of day that donations are made by the user relative to an amount of funds, donation amounts relative to age or another characteristic, and so on.

The interface 302 also includes bulleted statistics 306 regarding the donations of the user. The bulleted statistics 306 indicate that the user ranks in the top 95% for givers of his income level (e.g., based on an amount of donations, a number of donations, etc.), that most persons of the user's age (e.g., more than a particular percentage) donate $5,200 less than the user does annually, and that the user donates more frequently or larger donations when he is at home than when he is at work. In other examples, the bulleted statistics 306 may indicate other types of statistics that are specific to the user and/or across multiple users.

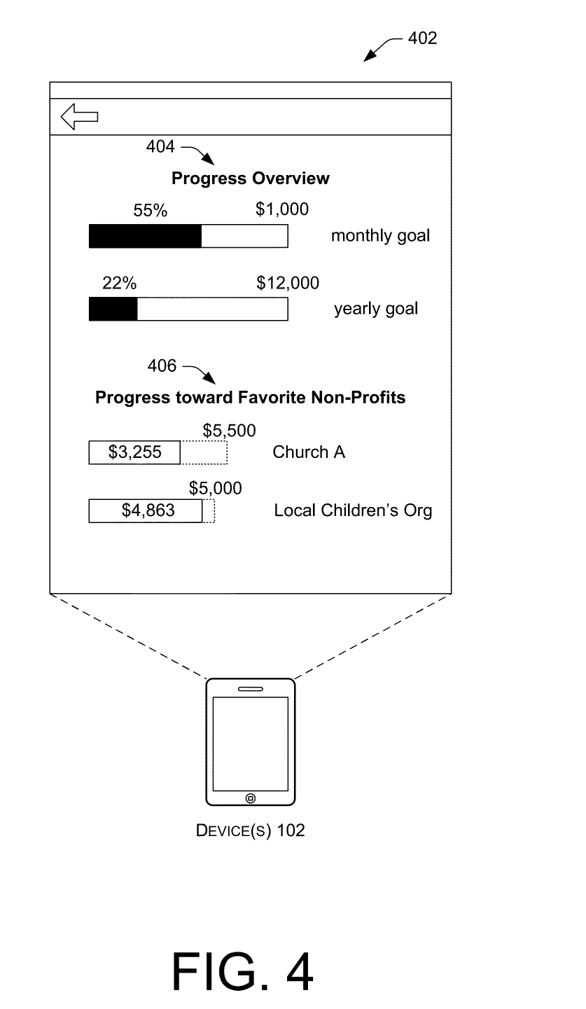

FIG. 4 illustrates an example interface 402 that displays progress of a user toward donation goals. The interface 402 may be presented in response to selection of the progress icon 224 in FIG. 2C. The interface 402 includes a progress overview area 404 that displays a general overview of the user's progress toward monthly and yearly goals. Here, the user's progress is based on an amount of funds that have been donated by the user across all non-profit organizations to which the user has donated. The interface 402 may also include an area 406 that displays the user's progress toward donation goals for specific non-profit organizations (e.g., favorite non-profits). Here, the user has set goals to donate a particular amount of funds to specific non-profit organizations.

In some instances, the interface 402 may enable the user to set donation goals and/or reminders to make donations toward those goals. For example, the text for the monthly goal (e.g., “$1,000”) may be adjustable so that the user can input a donation amount for the goal. Alternatively, or additionally, the interface 402 may include drop down menus, sliders, or other interface elements to create a donation goal and/or reminder. To illustrate, the user may set a goal to donate $4,500 over a 6-month period and set reminders to be presented each month indicating that the user should donate $750 that month in order to meet the 6-month goal.

Although the interface 402 illustrates progress toward goals that are specific to a particular user, in some instances the interface 402 may illustrate progress toward other types of goals. For example, if the user is participating in group giving where a group of users donate as a group to a particular cause/campaign, and the group has specified a goal, the interface 402 may display the group's progress toward that goal. In another example, the user may view progress for a goal that is set by a non-profit organization, such as progress toward a non-profit's goal to raise a particular amount of money by the end of the year. Here, the non-profit organization may be an organization that the user is following and/or that the user has saved to a favorites list.

FIGS. 5A-5B illustrated example interfaces 502 and 504 that display chain-of-impact information items that indicate an impact of donation activities associated with a user. The interfaces 502 and/or 504 may be presented in response to selection of the impact icon 226 in FIG. 2C. A donation activity that is “associated with a user” may comprise any donation activity of the user or any donation activity of other users that have been affected by a donation activity of the user. For example, a donation activity associated with a first user may comprise the first user inviting a second user to donate and/or the second user making a donation after receiving the invitation. If, for example, the second user causes a third user to make a donation (e.g., through an invitation to donate), the donation of the third user may be said to be “associated with” the first user since the first user triggered the second user's donation activities.

In FIG. 5A, a chain-of-impact information item is represented by a node graph 506 of nodes and edges connecting the nodes. The nodes represent users that are associate with donation activities (e.g., users that have been affected by donation activities), while the edges represent relationships between the users. As illustrated, the node graph 506 begins with a node 508 that represents the current user that is viewing the chain-of-impact information item. In some instances, the node graph 506 may be overlaid on a map with the nodes placed at locations of the users.

To illustrate the relationships between nodes of the node graph 506, assume that the user representing the node 508 invited two friends to donate to a particular cause and provides a link for the friends to donate to that cause. The two friends may be represented by the two nodes at the next lowest level in the node graph 506 (e.g., level two) and may be connected to the node 508 due to the invitations from the node 508. Thereafter, the friends donate to the cause by selecting the link and then invite five other friends to donate, as illustrated by the edges connecting the five nodes at the next lowest level (e.g., level three). Two of the users at that level in the node graph 506 share information with three other users. Accordingly, the node graph 506 includes ten nodes for the ten users that have been affected by donation activities that started with an invitation from the user of the node 508.

The interface 502 may also include information 510 that indicates an amount of funds that have been donated due to donation activities associated with the user of the node 508. This may include donations from any of the ten users represented in the node graph 506 of FIG. 5A.

In FIG. 5B, a chain-of-impact information item includes a geographical map 512 with markings at locations that have been affected by donation activities associated with a user. Here, the markings (e.g., nodes) are associated with organizations, individuals, or others that have been affected by a donation. To illustrate, assume that a user donates to a particular campaign of a non-profit organization to help clothe children. In this illustration, the non-profit organization is represented by a marking 514 that is located in southern California. With raised campaign funds, the non-profit organization clothes children in three areas, Wyoming, Texas, and Virginia, which are represented on the geographical map 512 with three markings and dotted lines connecting the markings.

FIG. 6 illustrates an example interface 602 to enable a user to create and share information regarding donation activities of the user. The interface 602 may be displayed in response to selection of the share icon 228 in FIGS. 2A-2C. The information may be shared as a notification, such as an email, text message, post, etc. In some instances, the information is shared with a user of a social networking site.

The interface 602 includes an area 604 that includes information to be shared with another user. Through a keyboard 606, the user may input text for a message to be shared (e.g., “John has generously donated to the XYZ non-profit organization to support . . . ”). Additionally, or alternatively, through a drop-down menu 608, the user may select other types of information to be shared, such as donation statistics of the user, general statistics of users that donate, or any type of donation information. Through an icon 610, the user may create an icon (e.g., link) to be included in the information to be shared. In this example, the user has created an icon 612 that may enable another user to donate to John's cause. The interface 602 may also include a drop-down menu 614 to specify to what social networking site the information in the area 604 will be shared (e.g., posted to). Upon selection of an icon 616, the user may share the information with another user and/or post the information to a social networking site or other site.

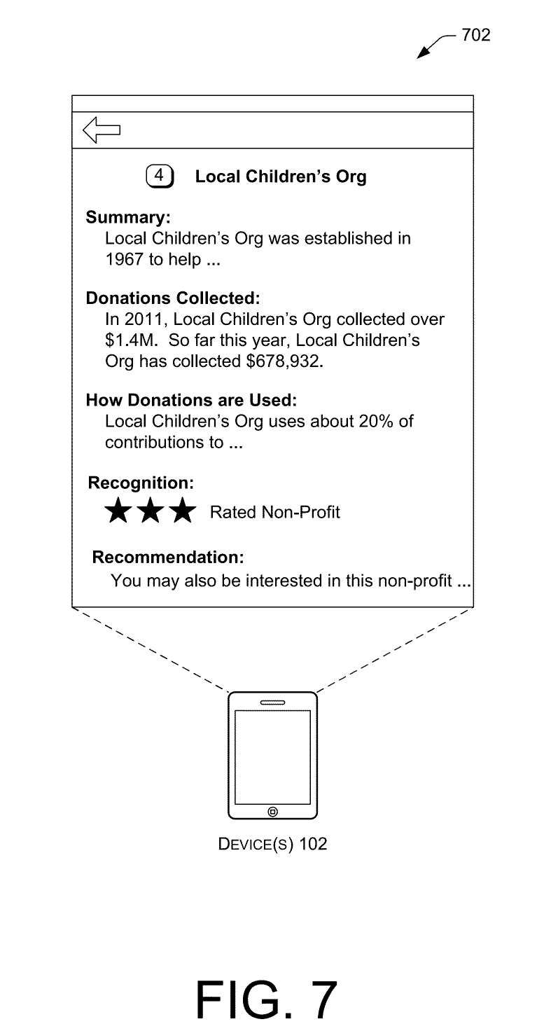

FIG. 7 illustrates an example interface 702 that displays information regarding a non-profit organization. In some instances, the interface 702 is displayed in response to the user requesting to view details of the Local Children's Organization of FIG. 2A (e.g., through selection of a marking on the map 210, through the selection in the listings 214, or otherwise). As illustrated, the interface 702 includes a summary of the Local Children's Organization (e.g., a mission statement, a date when the organization was established, etc.), information about donations that have been collected in preceding years and/or the current year, how donations are used, recognition of the organization (e.g., ratings/rankings, transparency scores, etc.), and a recommendation for another non-profit organization that the user may be interested in based on the user's interest in this organization and/or previous donations.

In some instances, the recognition section of the interface 702 may include a rating/ranking that is determined by the donation service 104 based on known information about the non-profit organization, such as a ratio of received funds to funds that are distributed to a cause, an amount of funds collected, a number of users that donate to the organization, and so on. Alternatively, or additionally, the rating/ranking may be generated by an association, governmental entity, or other organization.

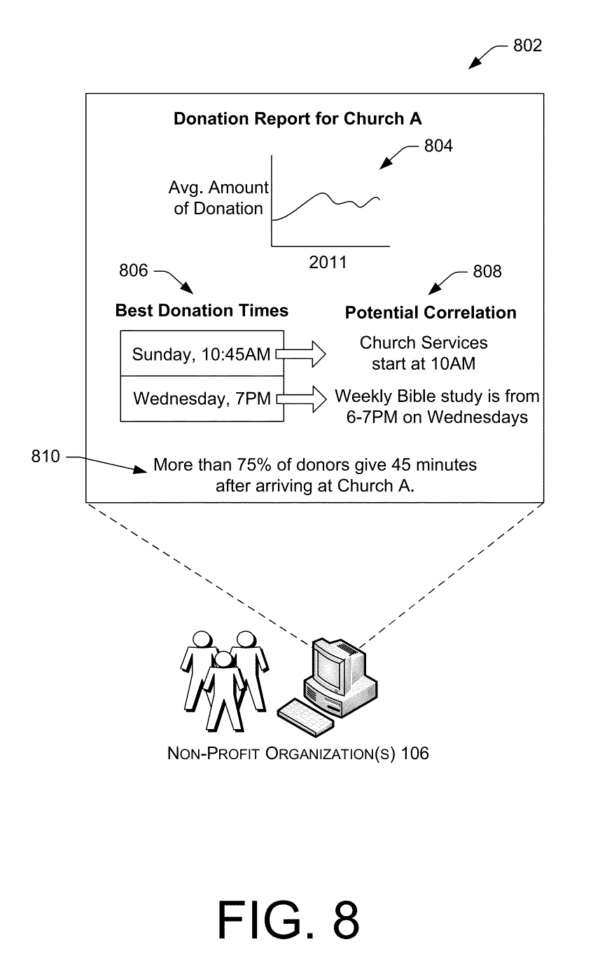

FIG. 8 illustrates an example interface 802 that displays a donation report for a particular non-profit organization. In this example, the donation report is provided to the non-profit organization 106, however, in other examples the report is provided to others. Here, Church A is attempting to schedule a fund raising campaign and has requested a donation report from the donation service 104 to assist them in planning the campaign. The donation report in this example is generated by the donation service 104 from donation activity data regarding donations to Church A. The donation report may assist Church A in planning when and where to publicize the fund raising campaign. Although the donation report is specific to a particular non-profit organization in FIG. 8, in other examples the report provides information for multiple non-profit organizations, for a particular user or user type, and so on.

As illustrated in FIG. 8, the donation report includes a graph 804 that indicates an average amount of donations that have been donated to Church A over time (e.g., over 2011). The donation report also includes best donation times 806 for Church A (e.g., best times of day). Here, the top two times are selected based on amounts of funds that are received throughout the day. The best donation times 806 may be displayed along with potential correlation events 808 that may provide some guidance as to why those times are the best donation times. In this example, Church A has provided the donation service 104 with its calendar, so that possible correlations between donation times and events may be identified (e.g., based on times of events in the calendar). The donation report also includes an interesting statistic 810 that the donation service 104 has identified, namely that more than 75% of donors give 45 minutes after arriving at Church A. This statistic is based on analyzing location information of donors when they gave to Church A.

Although not illustrated in FIG. 8, the donation report may include information regarding donations that have been pledged by users, such as an amount of funds that have been pledged. This may assist the non-profit organization in planning for how much funds will be received. Additionally, or alternatively, the donation report may indicate the types of users that have donated or pledged to donate. To illustrate, the report may indicate that users of a local gun club have donated more than a threshold amount of funds during the last month.

### Example Processes

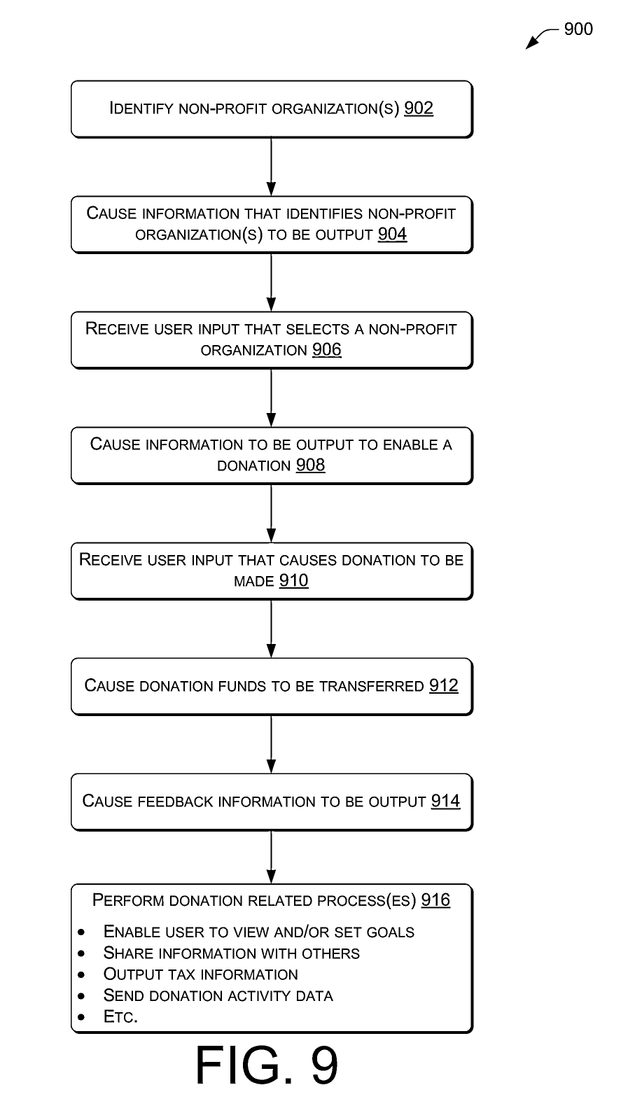

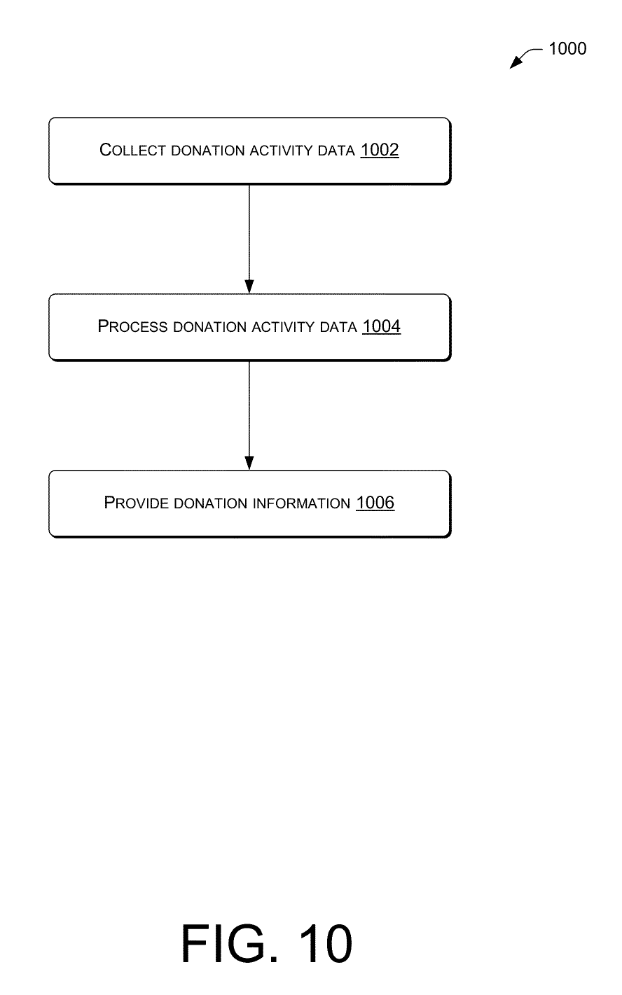

FIGS. 9 and 10 illustrates example processes 900 and 1000 for employing the techniques described herein. For ease of illustration the processes 900 and 1000 are described as being performed in the architecture 100 of FIG. 1. For example, one or more of the individual operations of the processes 900 and 1000 may be performed by the device 102 and/or the donation service 104. However, the processes 900 and 1000 may be performed in other architectures. Moreover, the architecture 100 may be used to perform other processes.

The processes 900 and 1000 (as well as each process described herein) are illustrated as a logical flow graph, each operation of which represents a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the process. Further, any number of the individual operations may be omitted.

FIG. 9 illustrates the example process 900 to facilitate a donation through the device 102. In this example, the process 900 is described as being performed by the device 102.

At 902, the device 102 may identify one or more non-profit organizations. In one example, the device 102 may search for non-profit organizations that have sites that are located within a predetermined distance to a location of the device 102. The search may further filter through the non-profit organizations to identify organizations that are running donation campaigns to raise money. In another example, the device 102 may search for non-profit organizations that satisfy an input query from a user of the device 102 (e.g., organization tagged as “Boy Scouts”). In yet another example, the device 102 may identify non-profit organizations that have been saved as favorites for a user of the device 102. In some instances of the operation 902, the one or more non-profit organizations are identified by receiving information from the donation service 104 (e.g., receive a list of non-profit organizations that are located proximate to the device 102).

At 904, the device 102 may cause information that identifies the one or more non-profit organizations to be output (e.g., displayed, output audio, etc.). In one example, this includes displaying a list of non-profit organizations that have sites that are located within proximity to the device 102. The list may be displayed with information regarding campaigns of the non-profit organizations. In another example, a geographical map is displayed with icons at locations of sites of non-profit organizations. In yet another example, search results may be displayed of non-profit organizations that satisfy input from a user. Here, the user may search through non-profit organizations of other users (e.g., friends).

At 906, the device 102 may receive user input that selects a non-profit organization from the one or more non-profit organizations that are output. This may include user input that is received through a touch screen or other input device of the device 102.

At 908, the device 102 may cause information to be output to enable a donation from a user of the device 102. For example, the device 102 may display the interface 204 of FIG. 2B that includes a number pad and other interface elements to allow the user to specify various parameters for making a donation.

At 910, the device 102 may receive user input that causes the donation to be made to the selected non-profit organization. The user input may be provided through the interface 204 of FIG. 2B along with other parameters for making a donation.

At 912, the device 102 may cause the donation funds to be transferred to the non-profit organization. This may include sending an instruction to the donation service 104 or another service to transfer funds from an account of the user to an account of the non-profit organization.

At 914, the device 102 may cause feedback information to be output. The feedback information may include information related to donation activities associated with the user. A donation activity may comprise making a donation to the selected non-profit organization (e.g., the current donation), making a pledge for a donation, sharing information with users regarding a donation, a donation activity of another user that has been notified about a donation activity of the user (e.g., a donation activity of a friend), and/or a donation activity of a further user that has been notified about a donation activity of the other user (e.g., donation activities of friends-of-friends). The feedback information may include, for example, a chain-of-impact information item, rewards (e.g., points, levels, etc.), a comparison information item, donation metrics, trends in donation activities, and so on.

At 916, the device 102 may perform one or more donation related processes. In one example, the device 102 may enable the user to set donation goals and/or view progress toward donation goals. In another example, the device 102 may enable the user to share information with an entity and/or user (e.g., share metrics to a social networking site). If the user has made a donation on behalf of another user (e.g., a friend or relative), then the user may send a notification to the other user indicating that the donation is being made on behalf of the other user (e.g., “Joe has made a contribution to your favorite charity in your behalf”). In yet another example, the device 102 may output tax information related to one or more donations from the user to non-profit organizations (e.g., different non-profit organizations). The tax information may be presented during tax season and may include information for all non-profit organizations to which the user has donated for a particular year. Alternatively, or additionally, the device 102 may send donation activity data to the donation service 104. The donation activity data may related to donations that the user has made through the device 102.

FIG. 10 illustrates the example process 1000 to analyze donation activity data to provide donation information. In this example, the process 1000 is described as being performed by the donation service 104.

At 1002, the donation service 104 may collect donation activity data from a plurality of devices (e.g., mobile devices). Donation activity data may relate to one or more donation activities that are at least partly carried out on a device of the plurality of devices. Donation activity data may indicate an amount of funds of a donation, a time that a donation is made, a location of a device at a time a donation was made, and/or a non-profit organization to which a donation was made.

At 1004, the donation service 104 may process the donation activity data from the plurality of devices to generate donation information. The donation information may indicate and/or include a best time of day at which donations are made, trends in donation activities, a donation metric, how long before arriving at a location a user made a donation, and so on. In one example, the donation information may comprise a donation metric for a plurality of users that are deemed to have similar characteristics. In some instances, the processing donation activity data includes determining when a user arrives at a particular location (e.g., a location of a site of a non-profit organization) and determining when a donation was made at that particular location.

At 1006, the donation service 104 may provide (e.g., send, display, etc.) the donation information. The donation information may be provided in a report to, for example, a non-profit organization to which the donation activity data relates, a user that made a donation, and/or another user or entity.

### CONCLUSION

Although embodiments have been described in language specific to structural features and/or methodological acts, it is to be understood that the disclosure is not necessarily limited to the specific features or acts described. Rather, the specific features and acts are disclosed herein as illustrative forms of implementing the embodiments.

What is claimed is:

1. A method comprising:
performing, by a mobile device, a donation process that enables a user to donate with a particular number of steps, the donation process consisting of:
a non-profit selection step in which a non-profit organization is selected;
a donation identification step in which a donation to be made to the selected non-profit organization is identified; and
a feedback step in which feedback information is output to the user, the feedback information relating to one or more donation activities associated with the user.

2. The method of claim 1, wherein the non-profit selection step includes receiving input from the user that selects a non-profit organization that is displayed through the mobile device.

3. The method of claim 1, wherein the non-profit selection step includes selecting a non-profit organization that has a site that is located within a predetermined distance to a location of the mobile device.

4. The method of claim 1, wherein the donation identification step includes receiving input from the user that specifies information for the donation.

5. The method of claim 1, wherein the feedback step includes displaying the feedback information through the mobile device to the user.

6. One or more computer-readable storage media storing computer-readable instructions that, when executed, instruct one or more processors to perform operations comprising:
identifying one or more non-profit organizations;
displaying information through a display of a mobile device that identifies the one or more non-profit organizations;
in response to receiving input from a user of the mobile device that selects a non-profit organization of the one or more non-profit organizations, displaying information through the display of the mobile device to enable a donation to the selected non-profit organization; and
in response to receiving input from the user that causes the donation to be made to the selected non-profit organization, displaying feedback information through the display of the mobile device regarding one or more donation activities associated with the user.

7. The one or more computer-readable storage media of claim 6, wherein the one or more donation activities associated with the user comprise at least one of making the donation to the selected non-profit organization, making a pledge for a donation, or sharing information regarding the donation to the selected non-profit organization.

8. The one or more computer-readable storage media of claim 6, wherein the one or more donation activities associated with the user comprise at least one of a donation activity of another user that has been notified about a donation activity of the user or a donation activity of a further user that has been notified about a donation activity of the other user.

9. The one or more computer-readable storage media of claim 6, wherein:
the identifying the one or more non-profit organizations comprises identifying a plurality of non-profit organizations that have sites that are located within a predetermined distance to a location of the mobile device; and
the displaying the information that identifies the one or more non-profit organizations comprises displaying a geographical map with a plurality of icons that represent the plurality of non-profit organizations, each of the plurality of icons being displayed on the map at a site of a non-profit organization of the plurality of non-profit organizations.

10. The one or more computer-readable storage media of claim 6, wherein the feedback information comprises a chain-of-impact information item that indicates an amount of funds that have been donated due to the one or more donation activities associated with the user.

11. The one or more computer-readable storage media of claim 6, wherein the feedback information comprises a chain-of-impact information item that includes a node graph of nodes and edges connecting the nodes, the nodes representing users that have been affected by the one or more donation activities associated with the user and the edges representing relationships between the users.

12. The one or more computer-readable storage media of claim 6, wherein the feedback information comprises a chain-of-impact information item that includes a geographical map with markings at locations that have been affected by the one or more donation activities associated with the user.

13. The one or more computer-readable storage media of claim 6, wherein the feedback information comprises at least one of points that the user has earned due to the one or more donation activities, a graphically displayed badge that the user has earned due to the one or more donation activities, a level of donation that the user has earned due to the one or more donation activities, an inspirational quote, an animation, or a donation metric associated with the one or more donation activities.

14. The one or more computer-readable storage media of claim 6, wherein the feedback information compares the one or more donation activities associated with the user with one or more donation activities associated with one or more other users.

15. The one or more computer-readable storage media of claim 6, wherein the feedback information indicates a trend in the one or more donation activities associated with the user over a period of time.

16. The one or more computer-readable storage media of claim 6, wherein the operations further comprise:
displaying information to enable the user to set one or more goals for donating;
wherein the feedback information indicates a progress of the user toward the one or more goals.

17. The one or more computer-readable storage media of claim 6, wherein the donation comprises a donation to be made on behalf of another user, the operations further comprising:
after receiving input from the user that causes the donation to be made to the selected non-profit organization, causing a notification to be sent to the other user indicating that the donation is being made on behalf of the other user.

18. The one or more computer-readable storage media of claim 17, wherein the identifying the one or more non-profit organizations comprises identifying a non-profit organization that is related to the other user.

19. A method comprising:
under control of a mobile device,
identifying one or more non-profit organizations that have sites that are located within a predetermined distance to a location of the mobile device;
causing a donation or pledge to be made to a particular non-profit organization of the one or more non-profit organizations; and
outputting feedback information through the mobile device regarding the donation or pledge and/or another donation or pledge.

20. The method of claim 19, further comprising:
causing a notification to be sent to a user of a social network regarding the donation or pledge.

21. The method of claim 19, wherein the identifying the one or more non-profit organizations comprises determining that the mobile device is located within the predetermined distance to a site of a particular non-profit organization that is running a campaign for donations.

22. The method of claim 19, wherein the donation or pledge to the particular non-profit organization comprises a donation or pledge for a group campaign in which a group of users donate to a particular cause.

23. The method of claim 19, further comprising:
providing donation activity data regarding the donation or pledge to a remote computing device for formulating donation information.

24. The method of claim 19, further comprising:
outputting tax information regarding a donation to the particular non-profit organization.

25. The method of claim 19, wherein the causing the donation or pledge to be made to the particular non-profit organization comprises causing funds to be transferred from an account of the user to an account of the identified non-profit organization.

26. One or more computer-readable storage media storing computer-readable instructions that, when executed, instruct one or more processors to perform operations comprising:
collecting donation activity data from a plurality of mobile devices, each piece of donation activity data regarding one or more donation activities that are at least partly carried out on a mobile device of the plurality of mobile devices;
processing the donation activity data from the plurality of mobile devices to generate donation information; and
providing the donation information to a non-profit organization.

27. The one or more computer-readable storage media of claim 26, wherein the donation activity data indicates an amount of funds of a donation, a time that the donation is made, a location of a mobile device of the plurality of mobile devices at the time the donation was made, and/or a non-profit organization to which the donation was made.

28. The one or more computer-readable storage media of claim 26, wherein the donation information indicates a time of day at which donations satisfy one or more criteria.

29. The one or more computer-readable storage media of claim 26, wherein the donation information indicates a trend in donation activities.

30. The one or more computer-readable storage media of claim 26, wherein the donation information comprises a donation metric for a plurality of users that are deemed to have one or more similar characteristics.

31. The one or more computer-readable storage media of claim 26, wherein:
the processing the donation activity data comprises determining when a user arrives at a particular location and determining when a donation was made at the particular location; and
the donation information indicates how long after arriving at the particular location the user made the donation.
